(19) United States
(12) Patent Application Publication
(10) Pub. No.: US 2019/0241140 A1
(43) Pub. Date: Aug. 8, 2019

(54) Vehicle Impact Detection System

(71) Applicant: Continental Automotive Systems, Inc., Auburn Hills, MI (US)

(72) Inventors: Christopher James Palazzolo, West Bloomfield, MI (US); Thierry Bersot, Grosse Pointe Woods, MI (US); Robert M Andres, Clarkston, MI (US)

(73) Assignee: Continental Automotive Systems, Inc., Auburn Hills, MI (US)

(21) Appl. No.: 16/269,206

(22) Filed: Feb. 6, 2019

Related U.S. Application Data
(60) Provisional application No. 62/626,864, filed on Feb. 6, 2018.

(51) Int. Cl. B60R 21/0136; B62D 25/04

(52) U.S. Cl. CPC B60R 21/0136; B60R 2021/01211; B62D 25/04

(57) ABSTRACT

An impact detection system for a vehicle having at least one structural pillar includes an impact sensor configured to generate a signal in response to detecting an impact on a side of the vehicle. The impact sensor is disposed on the at least one structural pillar of the vehicle.

### CROSS REFERENCE TO RELATED APPLICATION

This application claims the benefit of provisional patent application No. 62/626,864, filed Feb. 6, 2018, which is hereby incorporated by reference.

### TECHNICAL FIELD

The technical field relates generally to a system for detecting impacts on a vehicle.

### BACKGROUND

Side-impact airbags, such as side-curtain airbags, are frequently being offered in modern vehicles to provide protection in the event of a collision, crash, and/or other impact with a side of the vehicle and/or a roll-over of the vehicle. Typically, the impact sensor which initiates inflation of these airbags is mounted in the door of the vehicle.

However, some vehicles are equipped with doors that may be removed, e.g., some models of the Jeep® Wrangler. Further, some vehicles may be modified by their owners to remove the doors.

As such, it is desirable to present a system for detecting a side-impact of a vehicle without doors. In addition, other desirable features and characteristics will become apparent from the subsequent summary and detailed description, and the appended claims, taken in conjunction with the accompanying drawings and this background.

### BRIEF SUMMARY

In one exemplary embodiment, an impact detection system for a vehicle having at least one structural pillar includes an impact sensor configured to generate a signal in response to detecting an impact on a side of the vehicle. The impact sensor is disposed on the at least one structural pillar of the vehicle.

### BRIEF DESCRIPTION OF THE DRAWINGS

Other advantages of the disclosed subject matter will be readily appreciated, as the same becomes better understood by reference to the following detailed description when considered in connection with the accompanying drawings wherein:

FIG. 1 is a block diagram of a vehicle with an impact detection system; and

FIG. 2 is perspective view of a portion of a structural body of the vehicle.

### DETAILED DESCRIPTION

Referring to the Figures, wherein like numerals indicate like parts throughout the several views, a vehicle 100 with an impact detection system 102 is shown and described herein.

In the exemplary embodiment, the vehicle 100 includes at least one structural pillar 200. FIG. 2 shows a portion of a structural body 202 of the vehicle including the at least one structural pillar 200. Particularly, in this exemplary embodiment, the structural pillar 200 is a B-pillar 204 of the vehicle 100. The B-pillar is shown in FIG. 2 as extending upward from a rocker 205.

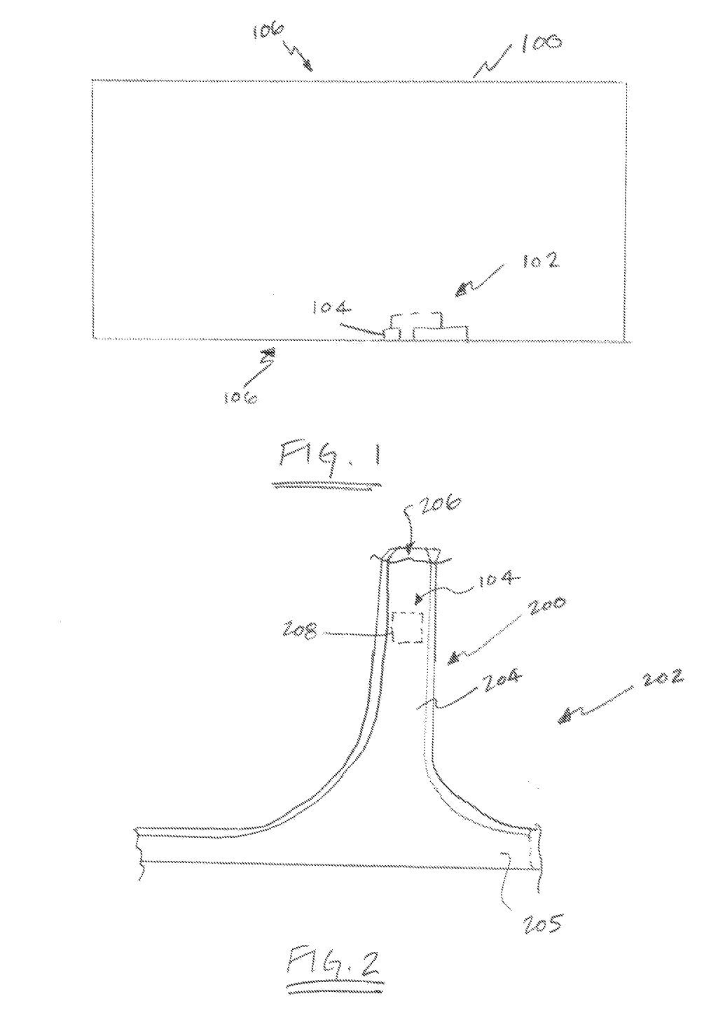

The impact detection system 102 includes an impact sensor 104, shown in FIGS. 1 and 2. The impact sensor 104 is configured to generate a signal in response to detecting an impact on a side 106 of the vehicle 100.

In the exemplary embodiment, the impact sensor 104 is disposed on the at least one structural pillar 200 of the vehicle 100. More particularly, in the exemplary embodiment, the impact sensor 104 is disposed on the B-pillar 204. Even more particularly, in the exemplary embodiment, the B-pillar 204 defines a cavity 206, e.g., a channel, and the impact sensor 104 is disposed in the cavity 206.

In the exemplary embodiment, the impact sensor 104 is a pressure sensor 208. The pressure sensor 208 is configured to generate the signal in response to a change in pressure being indicative of an impact. That is, when a collision, crash, and/or other impact occurs with the side 106 of the vehicle 100, a rapid change in volume may occur within the cavity 206 of the B-pillar 204. The pressure sensor 208 detects that change in volume as a change in pressure and generates the signal that is indicative of an impact with the side 106 of the vehicle 100. Since the pillar 200 of the vehicle may not experience substantial vibration and/or acceleration during an impact, utilizing the pressure sensor 208 is advantageous for detecting the impact.

In another embodiment, the pressure sensor 208 may be located in a structural pillar 200 other than the B-pillar 204. In yet other embodiments, the pressure sensor 208 may be disposed in other structural cavity locations of the vehicle 100, in addition to and/or instead of one of the structural pillars 200. These positions may be at any location on the vehicle 100, i.e., not just the sides 106 of the vehicle 100.

In another embodiment, the impact sensor 104 may be implemented with a sensing bladder. In yet another embodiment, the impact sensor 104 may be implemented with an acceleration based sensor, i.e., an accelerometer.

Referring again to FIG. 1, the vehicle may also include an airbag 108. The airbag 108 may be mounted on the side 106 of the vehicle 100, i.e., a side-mounted airbag 108. The airbag 108 is configured to inflate in response to the signal, provided by the impact sensor 104 detecting an impact on a side of the vehicle.

The present invention has been described herein in an illustrative manner, and it is to be understood that the terminology which has been used is intended to be in the nature of words of description rather than of limitation. Obviously, many modifications and variations of the invention are possible in light of the above teachings. The invention may be practiced otherwise than as specifically described within the scope of the appended claims.

What is claimed is:

1. An impact detection system for a vehicle having at least one structural pillar, said system comprising:
an impact sensor configured to generate a signal in response to detecting an impact on a side of the vehicle;
wherein said impact sensor is disposed on the at least one structural pillar of the vehicle.

2. The impact detection system as set forth in claim 1 wherein said impact sensor is a pressure sensor configured to generate the signal in response to a change in pressure being indicative of an impact.

3. The impact detection system as set forth in claim 1 wherein the at least one structural pillar defines a cavity and wherein said impact sensor is disposed in the cavity.

4. The impact detection system as set forth in claim 3 wherein said impact sensor is a pressure sensor configured to generate the signal in response to a change in pressure being indicative of an impact.

5. The impact detection system as set forth in claim 1 wherein the at least one structural pillar includes a B-pillar and wherein said impact sensor is disposed on the B-pillar.

6. The impact detection system as set forth in claim 5 wherein the B-pillar defines a cavity and wherein said impact sensor is disposed in the cavity.

7. The impact detection system as set forth in claim 7 wherein said impact sensor is a pressure sensor configured to generate the signal in response to a change in pressure being indicative of an impact.

8. A vehicle comprising:
at least one structural pillar;
an impact sensor configured to generate a signal in response to detecting an impact on a side of said vehicle;
wherein said impact sensor is disposed on said at least one structural pillar of the vehicle.

9. The vehicle as set forth in claim 8, wherein the at least one structural pillar includes a B-pillar and wherein said impact sensor is disposed on said B-pillar.

10. The vehicle as set forth in claim 9, wherein said B-pillar defines a cavity and wherein said impact sensor is disposed in said cavity.

11. The vehicle as set forth in claim 10, wherein said impact sensor is a pressure sensor configured to generate the signal in response to a change in pressure being indicative of an impact.

12. The vehicle as set forth in claim 11, further comprising an airbag configured to inflate in response to the signal detecting an impact on a side of said vehicle.

13. The vehicle as set forth in claim 12, wherein said airbag is mounted on said side of said vehicle.
